(19) United States
(12) Patent Application Publication
(10) Pub. No.: US 2008/0227466 A1
(43) Pub. Date: Sep. 18, 2008

(54) Modular GPS system for breathalyzer interlock

(76) Inventors: Michael C. Rabanne, Stansbury Park, UT (US); Thomas A. Hoopes, Sandy, UT (US)

Correspondence Address: MORRISS OBRYANT COMPAGNI, P.C., 734 EAST 200 SOUTH, SALT LAKE CITY, UT, 84102, US

(21) Appl. No.: 12/075,305

(22) Filed: Mar. 10, 2008

Related U.S. Application Data
(60) Provisional application No. 60/905,995, filed on Mar. 9, 2007.

(51) Int. Cl. H04Q 7/20; G08B 23/00

(52) U.S. Cl. 455/456.1; 340/576

(57) ABSTRACT

The present invention provides apparatus, systems and methods for determining positional information and transmitting that information over a cell phone network in connection with a sobriety interlock system.

### CROSS-REFERENCE TO RELATED APPLICATION

This application claims the benefit of U.S. Provisional Application No. 60/905,995, filed Mar. 9, 2007, which is incorporated herein by reference in its entirety.

### TECHNICAL FIELD

The present invention relates to systems, apparatus, and methods for tracking and/or transmitting location information, such as digital Global Position Satellite (GPS) information, in connection with an alcohol sensor, sobriety interlock, associated with a vehicle.

### BACKGROUND

Transportable devices which detect and transmit locational information have been developed. For example, U.S. Patent Application Publication Number U.S. 2003/0160725 to Baxter, the disclosure of which is incorporated by reference, discloses a GPS unit located in the handset of a radio. Likewise, other systems using digital communications have been developed.

U.S. Pat. No. 4,912,458, the entirety of which is incorporated by reference, discloses a sobriety interlock system that requires the driver of a vehicle to blow a breath sample into a measuring device before starting the vehicle. If the measuring device registers an alcohol content above a legal, or other predetermined, limit in the breath sample, ignition of the vehicle is prevented. The DRAGER INTERLOCK® XT provides an example of a sobriety interlock system.

Similarly, U.S. Pat. No. 6,075,444, the disclosure of which is incorporated by reference, discloses a sobriety interlock system where the blood alcohol content is measured via permeation through the skin of the operator.

U.S. Pat. No. 5,736,962, the disclosure of which is incorporated by reference, discloses a wireless emergency location system in which a cellular phone is utilized to communicate the location of an individual or vehicle based on the output of a GPS receiver and additional information.

While such interlock and other such systems may contain relatively complex data retention capabilities, they do not detect or record the location of the driver. Likewise, any data retention capability is contained solely within the sobriety interlock system. However, in the case of a parent or guardian trying to prevent drunk driving by a child it would be desirable to provide information to the parent or guardian as incidences may occur.

Thus, a sobriety interlock system and methods that can transmit location data and other desirable information would be an improvement in the art.

### SUMMARY

The present invention provides apparatus, systems and methods for determining positional information and transmitting that information over a cell phone or other communications network in connection with a sobriety interlock system.

The invention relates to a sobriety interlock position information communication system that includes a position information receiver (PIR), such as a Global Position Satellite (GPS) receiver, connected to a microcontroller and a wireless communications device in connection with a sobriety interlock system.

In an exemplary embodiment, the PIR receives locational information, processes the information to create coordinate data regarding the unit's location, and passes the coordinate data to or through a microcontroller or processor connected to a SIM card and SIM card interface, which then transmits the coordinate data to another location via a wireless mobile communications network. The coordinate data may then be converted into any desirable format, for example, a format compatible with electronic mapping/location software that can be forwarded to a computer operating such mapping/location software.

### DESCRIPTION OF THE DRAWINGS

It will be appreciated by those of ordinary skill in the art that the elements depicted in the various drawings are for exemplary purposes only. The nature of the present invention, including the best mode, as well as other embodiments of the present invention, may be more clearly understood by reference to the following detailed description of the invention, to the appended claims, and to the several drawings.

FIG. 1 is a schematic of a set of components for one illustrative embodiment of a position information receiver (PIR) connected to a microcontroller and a communications device comprising a subscriber identification module (SIM) card, in accordance with the principles of the present invention.

FIG. 2 illustrates a front view of an exemplary embodiment of an interlock position communication system placed in communication with a sobriety interlock system in accordance with the principles of the present invention.

FIG. 2A is a schematic wiring diagram of an exemplary embodiment of an interlock position communication system hard wired to the ignition system of a vehicle in accordance with the principles of the present invention.

FIG. 3 illustrates an enlarged cutaway view of the embodiment of FIG. 2 in attachment to a sobriety interlock system.

FIG. 3A illustrates the enlarged cutaway view of the embodiment of FIG. 3 with a key inserted therein.

FIG. 4 illustrates a top perspective view of the interlock positioning communication system of FIGS. 2 and 3.

FIG. 5 is a front view of another exemplary embodiment of an interlock position communication system placed in communication with an external computer system in accordance with the principles of the present invention.

FIG. 6 is a front view of yet another exemplary embodiment of an interlock position communication system integrated into a sobriety interlock system in accordance with the principles of the present invention.

### DETAILED DESCRIPTION

The present invention relates to apparatus, systems and methods related to the transmission of location (position) information, such as digital Global Position Satellite (GPS) location information over existing cell phone networks or other communication networks, in connection with a sobriety interlock system. It will be appreciated by those skilled in the art that the embodiments herein described, while illustrating certain embodiments, are not intended to so limit the invention or the scope of the appended claims. Those skilled in the art will also understand that various combinations or modifications of the embodiments presented herein can be made without departing from the scope of the invention. All such alternate embodiments are within the scope of the present invention. Similarly, while the drawings depict illustrative embodiments of devices and components in accordance with the present invention and illustrate the principles upon which the depicted device or component is based, they are only illustrative and any modification of the invented features presented herein are to be considered within the scope of this invention.

The present invention utilizes a wireless communication system to transmit location information and other information to another location, such as a central receiving station or another device connected to the wireless communication system. In an exemplary embodiment, the wireless communication system is a mobile phone system, for example, an AMPS, GSM, D-AMPS, GPRS, EV-DO, CDMA, TDMA, UMTS or iDEN based mobile phone system, or a satellite phone system. While a satellite based system may be more expensive to operate than a mobile phone based system, the use of a satellite communication system to transmit location information has the advantage of working almost anywhere on earth, while a mobile phone system has limited geographical coverage. In an exemplary embodiment, the invention provides a wireless communication system that has the ability to recognize a mobile phone network within operational distance, determine the broadcast frequency and communication protocol used by that network, and to transmit and receive signals from that network (e.g., to switch between a GSM based network and a CDMA based network).

As used herein, “Subscriber Identity Module card” or “SIM card” includes a Universal Subscriber Identity Module (USIM) and a Removable User Identity Module (RUIM) or any other card capable of connecting to and communicating through a wireless communication network or mobile phone system.

In an exemplary embodiment, a SIM card will control access to any available wireless communication network (e.g., will provide authentication, data storage, and ciphering), such that the SIM card will allow the unit to recognize different cell tower networks and adapt to the appropriate data transmission protocol.

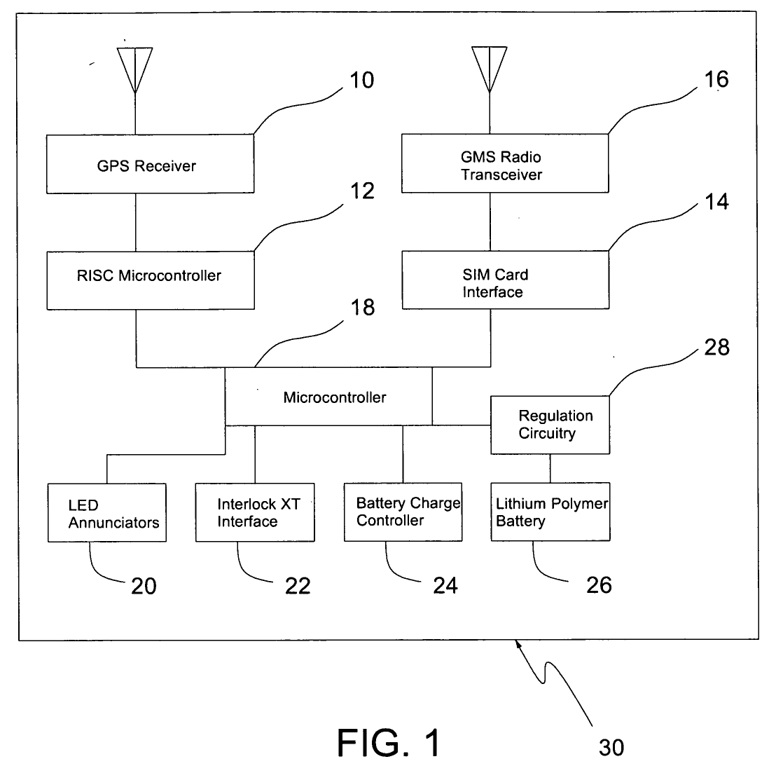

FIG. 1 depicts a schematic for a GPS receiver 10, which in combination with a RISK Microcontroller 12, a SIM card interface 14, and a wireless communication transceiver 16 form an interlock position communication system (IPCS) 30 that permits the transmission of locational information, such as Global Position Satellite (GPS) information, over an existing wireless communication network, wherein this system is connected to and interacts with a sobriety interlock system. For example, in FIG. 1 the GPS receiver 10 and wireless communication transceiver 16 as shown connected to the microcontroller 18 of a sobriety interlock that contains LED annunciators 20, an Interlock XT interface 22, battery charge controller 24, a battery 26 (such as a lithium polymer battery), and regulation circuitry 28. It will be appreciated that where the individual functions of any combination of these components may be performed by a single microcontroller executing a suitable software program, such embodiment may be used within the scope of the present invention.

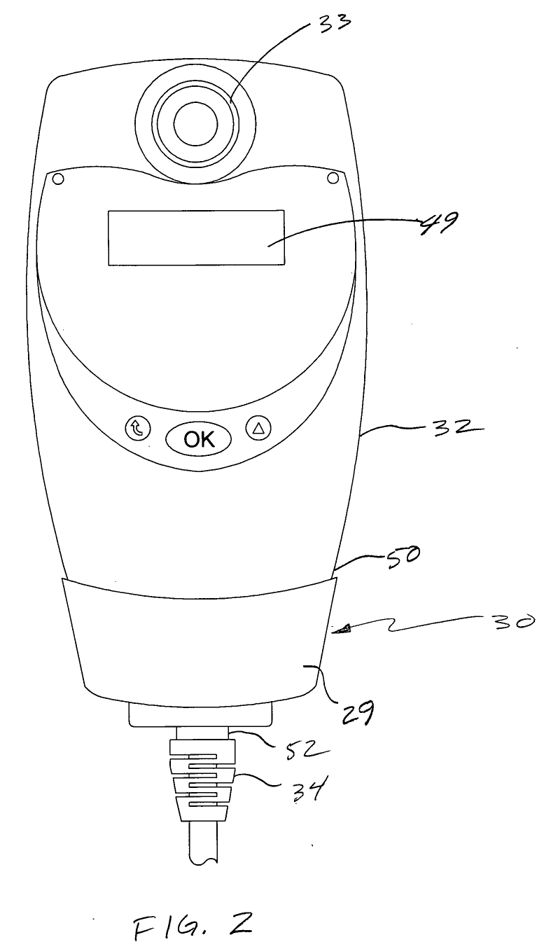

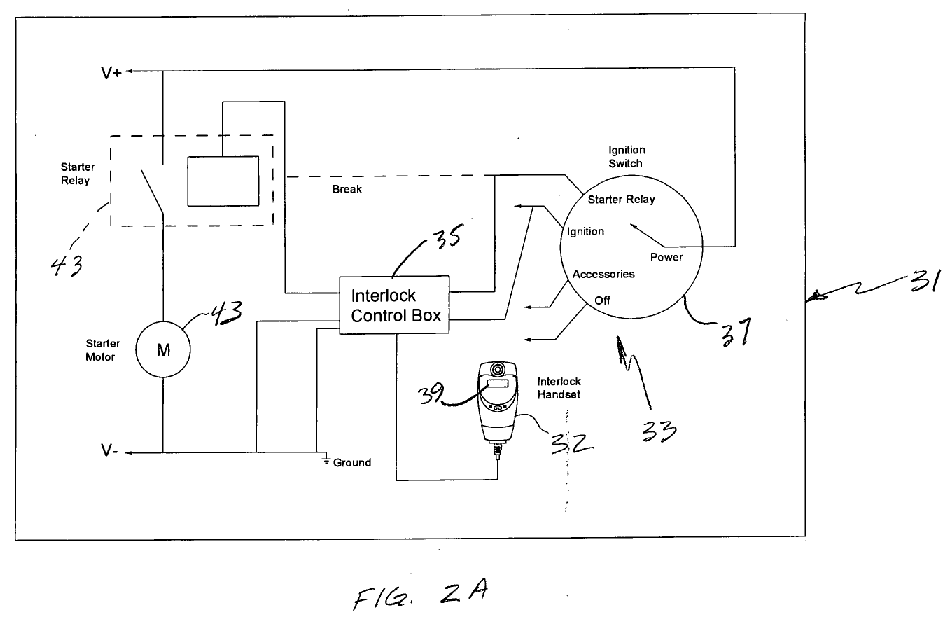

FIG. 2 illustrates an interlock position communication system (IPCS) 30 that is adapted to connect to a sobriety interlock handset 32, in this embodiment a DRAGER INTERLOCK® XT sobriety interlock handset. The interlock handset 32 is a breath alcohol measuring instrument with vehicle immobilizer that is configured to be installed in a motor vehicle. Upon activation of the ignition switch of the vehicle and before the vehicle can be started, the handset 32, via the LCD screen 49 will indicate to the intended driver of the vehicle that a breath sample is required. The breath sample is given by the driver through the mouth piece 33. The interlock is capable of detecting and determining breath alcohol content. If an excessive alcohol is detected, the interlock will indicate to the driver via the LCD screen 49 that an excessive breath alcohol content has been detected and will send a signal that will prevent the engine of the vehicle from being started.

The IPCS 30 is adapted to couple to the handset 32 in a manner that complements the aesthetic look of the handset 32 while providing a substantially rigid and durable interconnection system. In effect, the IPCS 30 includes a housing 29 sized to receive and support the proximal end 50 of the handset 32. In order to attach the IPCS 30 to the handset 32, the cable 34 is removed from the handset 32, the IPCS 30 is coupled to the handset 32, and the cable 34 is connected to the IPCS 30. Thus, the IPCS 30 is interconnected between the handset 32 and the cable 34 without requiring modification of either component. The IPCS 30 thus includes an electronic connector (as will be described in more detail) that is similar in configuration to the distal end 52 of the cable 34 so as to be electronically coupled to the handset 32.

As shown in FIG. 2A, the interlock system 31 is coupled to the ignition system 33 of a vehicle. The interlock system 31 is comprised of two main components: the breath alcohol measuring instrument which is included in the handset 32 and the interlock control box 35 which may be installed under the dash-board of the vehicle and that prevents the vehicle's ignition system 33 from starting the vehicle. When the ignition switch 37 is turned on, the interlock control box 35 sends a signal to the interlock handset 32. The handset 32, via the LCD screen 39 requests a breath sample from the driver. The result of the breath alcohol concentration measurement performed by the handset 32 determines whether the vehicle's starter motor 43 will be activated to allow the engine to be started. That is, if alcohol is detected by the interlock handset 32, the interlock control box 35 will interrupt the signal between the ignition switch 37 and the starter relay 43 and prevent the starter motor 41 from being activated, thus preventing the vehicle from being started. The interlock handset determines the breath alcohol concentration by means of an electrochemical sensor. The sampling system conveys a breath sample of a precisely defined volume to the electrochemical sensor. The sensor determines the ethanol content of the breath sample selectively and with a high degree of accuracy. The sensor contains an electrolyte-soaked membrane which carries the measurement electrode and the counter-electrode. The electrolyte and the electrode material are chosen such that the alcohol to be analyzed is oxidized electrochemically on the catalyst layer of the measurement electrode. The electrons released from the reaction at the electrode dissipate the current through the connecting wires to the instrument's electronics. When the sensor current is analyzed, the entire electric charge generated during the electrochemical reaction is determined.

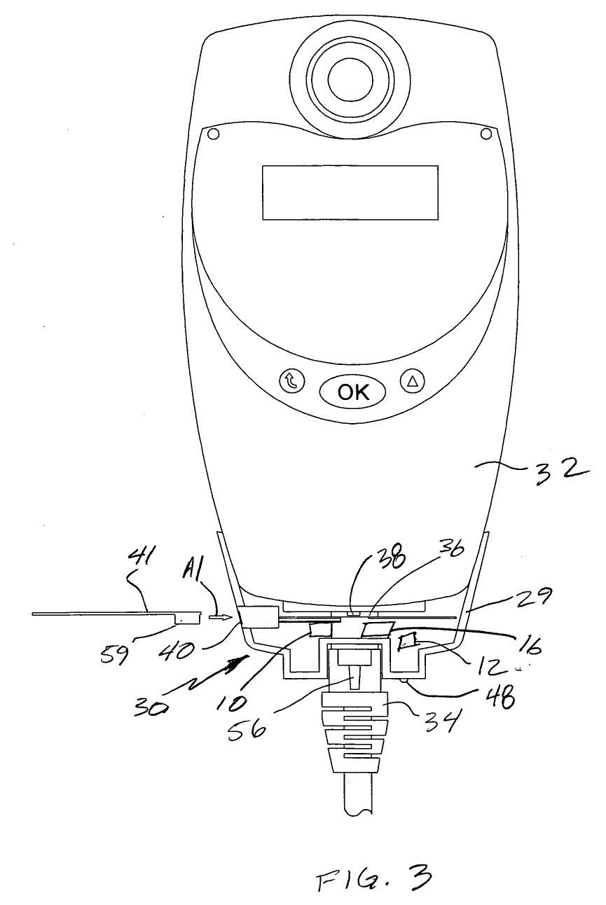

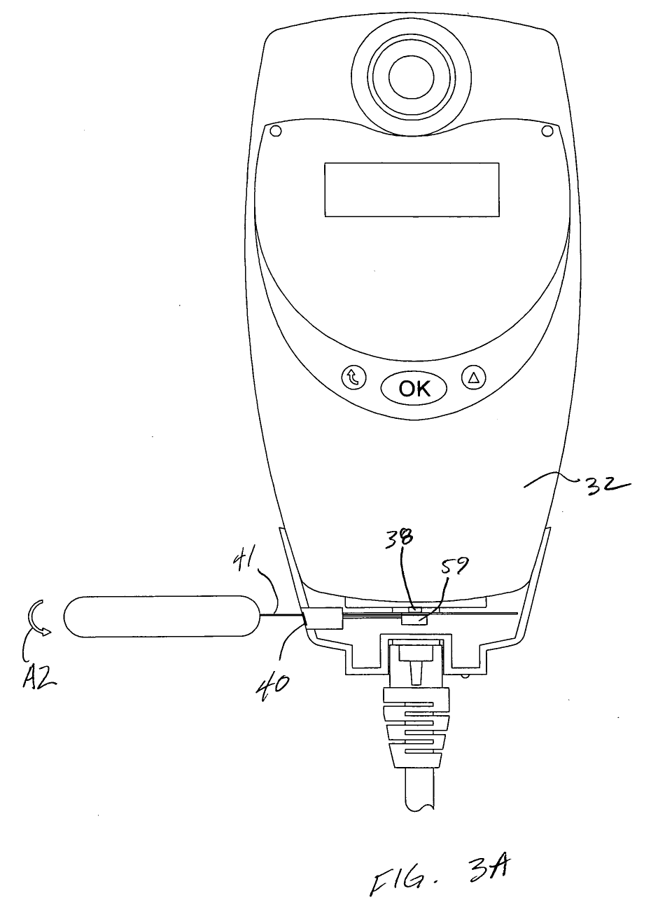

FIG. 3 illustrates an IPCS 30 connected to the sobriety interlock handset 32 by means of a connector 36. The IPCS 30 is also configured to connect to the cable 34 of the interlock handset 32 which is connected to the control unit 35 (see FIG. 2A) that is in turn connected (e.g., hard wired) to the vehicles electronics (see FIG. 2A), particularly the engine starter motor 43. The IPCS 30 may optionally have one or more LEDs 48 that indicate the status of the IPCS 30. The connector 36 is optionally configured with a latch or tab 38 similar in configuration to the biased tab 56 associated with the cable 34. The tab 56 is depressed for releasing the cable from the IPCS 30, similar to the tab found on a common telephone jack cord. By rigidly fixing the connector 36 to the housing 29 of the IPCS 30, the connector 36 and associated latch or tab 38 provide a releasable attachment of the IPCS 30 to the handset 32. In order to remove the IPCS 30 from the handset 32, a key may be employed. As further illustrated in FIG. 3A, the key 41 is inserted as indicated by arrow A1 through the orifice 40. Once inserted, rotation of the key, as indicated by arrow A2 will cause the protruding end portion 59 of the key 41 to rotate and depress the tab 38. Once depressed, the connector 36 can be removed from the handset 32.

The connector 36 is electronically connected to the GPS receiver 10 and wireless communication transceiver 16, which is in turn electronically connected to the cable 34.

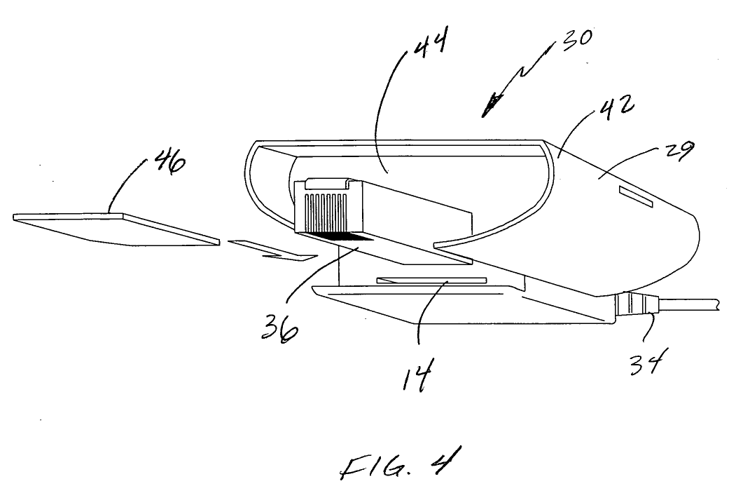

FIG. 4 further illustrates an exemplary embodiment of the IPCS 30, including the cable 34, connector 36, and a SIM card interface 14 for receiving a SIM card 46. The IPCS 30 also includes the GPS receiver 10, microcontroller 12, SIM card 14, radio transceiver 16, memory, such as flash memory, a data port, or a combination thereof, all contained within the housing 29. Wall 42 forms the housing 29 and a pocket or receptacle 44 that adapts the IPCS 30 for connection to the sobriety interlock 32. SIM card 46 is configured to allow the IPCS 30 to connect to a mobile communications network, such as a cellular telephone network, either to transmit or to receive data.

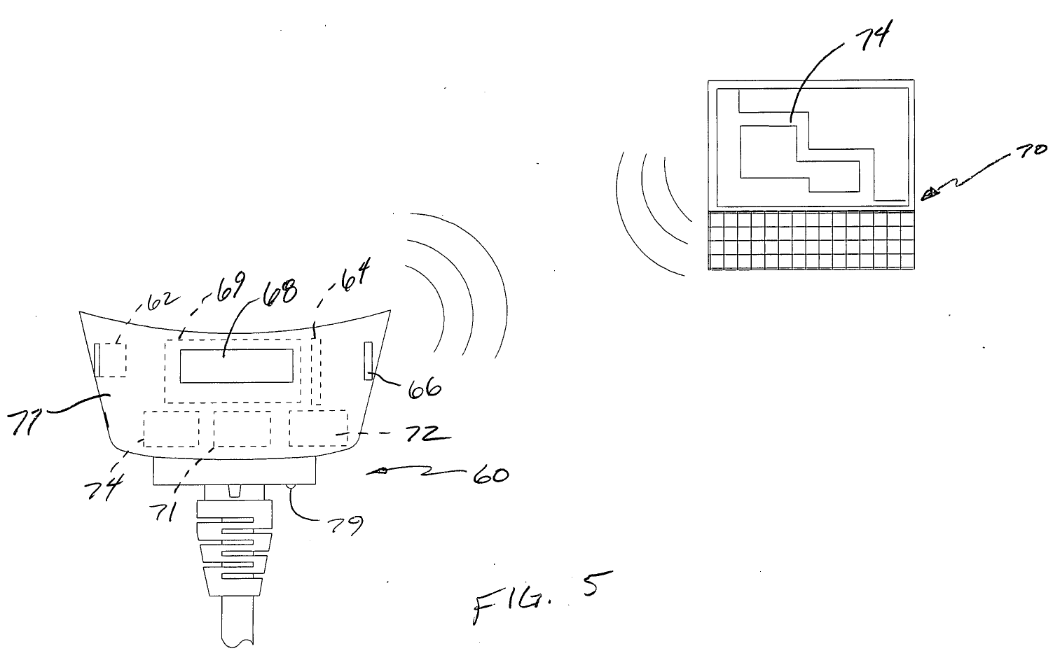

As shown in FIG. 5, an IPCS 60 according to the present invention may contain one or more memory units 62, such as flash memory, a wireless network antenna 64, a data port, such as a USB port, a video display 68, such as an LCD, plasma, or LED screen, microprocessor 69 and other circuitry to allow operation of the device. In addition, a computer system 70, such as a computer or computer network running electronic mapping software 74 may automatically track the locations of the various IPCS units 60 or other devices transmitting position information. An IPCS 60 may automatically assemble “real-time” lists of unique identifiers and their locations transmitted to it by way of the transceiver 72. Such information may be transmitted directly from another IPCS 60 or be sent to the IPCS 60 from a central receiving station 70. An IPCS 60 may then decode the information and utilize a video display 68 to present the appropriate information. Other information may similarly be conveyed to the IPCS 60, or sent from the IPCS 60, using the transceiver 72.

In an exemplary embodiment, locational or positional information may be obtained through the use of the wireless communications device 74, for example, an e-GPS unit that wirelessly interacts with multiple cellular towers to ascertain its location by triangulation and the length of time required to receive a signal from each of the multiple cellular towers may be used. One suitable e-GPS interface may be that commercially available from Cell-Guide of Revovot, Israel. In addition, a hybrid of the GPS and tower-distance approaches may also be used. In this embodiment, the position information receiver (PIR) 74 may be contained within the wireless communication mechanism.

While a GPS or e-GPS system is currently preferred, the PIR 74 may be a receiver that interacts with one or more positional satellite systems, including, but not limited to, global navigation satellite system (GLONASS), the Galileo positioning system which is being built by the European Union and others, a GPS system, or any other system capable of generating positional information, including alternate positioning systems such as an inertial navigational unit (INU), or other suitable locating system. In an exemplary embodiment, the PIR is configured to utilize multiple positional satellite systems and the IPCS 60 may be programmed to automatically, and/or by user input, utilize the desired system. For example, the IPCS 60 may be configured to receive and utilize positional information from both the US based GPS system and the European based Galileo system, and the user may select a desired position information system (e.g., GPS or Galileo), and/or the IPCS 60 may switch to an alternate positional system where reception of a signal from one system is blocked, but reception of a signal from an alternate system is available.

The circuitry for the IPCS 60 may be mounted within a small self-contained unit 77 that is configured for attachment to a sobriety interlock device 32 or is integrated therein. In the exemplary embodiments illustrated in FIGS. 2-5, the IPCS 60 may be connected to the sobriety interlock device 32 through a standard accessory port, USB port, or another port. In another exemplary embodiment, the IPCS 60 may be connected to, or include a, a parent or local device that communicates with at least one child or remote device that is attached to objects that are proximate to the parent or local device, wherein the child device may be connected to any desirable object such as a portable computer, a day planner note book, a mobile telephone, a set of car keys, a pet, etc. In this embodiment, the parent device may be connected to the sobriety interlock and may be used by an operator thereof to manage or track the objects by allowing the person to program the parent and child devices according to the person's desired management parameters. For example, the person could attach a child device to their mobile telephone and program the parent device to indicate when the mobile telephone exceeds a particular distance from the parent device. If the person has intentionally left the mobile telephone in a remote location that exceeds the particular distance that was programmed into the parent device, the person can de-activate the child device of the mobile telephone by indicating to the parent device that it should temporarily ignore signals from the mobile telephone device. Advantageously, the parent device can de-activate a single child device without affecting any other child devices. It should be noted that the parent and child devices include circuitry that may include processors, microprocessors, or analog or solid state electrical circuitry for programming numerous functions according to the desires of the operating person. See U.S. Pat. No. 6,084,517, the entirety of which is incorporated by reference.

Mobile phone communications may be made to any standard cell phone tower using the appropriate communications system for that country or geographical region. Significantly, in some embodiments, no alteration of the target sobriety interlock device 32 is made other than connection thereto, e.g., by a cable, data or expansion port.

In an exemplary embodiment, the IPCS 60 is configured to electrically connect to the sobriety interlock device 32 (see FIG. 1), such that the sobriety interlock device's 32 power source provides power to the IPCS 60. Alternatively, the IPCS 60 may have an independent power source such as battery 71.

Accordingly, where the PIR 74 is a GPS receiver that interacts with GPS satellites to determine the location of the PIR 74, the IPCS 60 includes the hardware and/or software necessary to convert signals from the GPS satellites into positional information and to transmit that information over the appropriate wireless communication network.

Where an alternate positioning system forms part of the PIR 74, (or a separate alternate positioning system is included in the PIR 74), such an alternate positioning system may allow for tracking of the unit where GPS or e-GPS information is not available, through “dead reckoning.” For example, an inertial navigational unit (INU) or motion sensing components, such as accelerometers, magnetometers, or gyros may be included in the PIR 74. Where present, it is preferred that multiple units be included (where required) to allow for tracking of motion along all three directional axes (x, y, and z). Data on motion detected by such components may be supplied to the microcontroller 69. When the PIR 74 is unable to obtain positional information from an outside source (such as GPS satellite signal information), the microcontroller 69 uses the data on motion detected by motion sensing components and supplied to it since the last detected outside positional information to calculate an approximate position for the PIR 74. The locational information for the calculated approximate position may then be utilized in the same manner as locational information detected from an outside source.

An indicator may be present on the PIR, such as an LED 79 visible on the IPCS 60 to inform a user of the status of the locational information. When the PIR 74 is able to obtain locational information from an outside source, such as GPS satellite information, the indicator may be actuated to alert the user. Thus the LED may be lit when there is a GPS “lock.” Alternatively, the indicator may alert the user that outside locational information is not available and a “dead reckoning system” or a last known reading is being utilized.

An IPCS 60 may comprise or be connected to a user identification system, for example, a finger print reader, swipe card, retinal scanner or other such device.

It will be appreciated that locational information may be transmitted by the IPCS 60 every time the sobriety interlock is activated, at automatic time intervals, only when the locational information has changed since a prior transmission, at preset time intervals (which may alter when the IPCS 30 is stationary), if the IPCS 30 enters a predetermined area (a hot spot or forbidden zone), or if the sobriety interlock breathalyzer test is failed. The IPCS 30 may also store a last “good” set of locational data, in the event the user enters an area where reception of locational information (such as GPS satellite data) is obscured.

The IPCS 60 may also be assigned and retain a unique identification key ID, which is transmitted as an ID data packet. Transmission of the packet can allow another location tracking or monitoring multiple IPCS 60 to keep track of individual IPCS 60.

The data format for the locational information, and any other data, delivered through the radio transceiver 72 may be determined by the needs of the user of the system. For example, where the user is a central receiving station, a number of IPCS 60 may be monitored. In addition, any desirable data contained by the sobriety interlock device 32, such as the results of a breathalyzer analysis, may be transmitted to a central location, where that data may be routed accordingly. In an exemplary embodiment, locational data, time and results of any breathalyzer analysis, and/or the location of other objects or individuals may be transmitted by the central receiving station. In this embodiment, a party may be informed regarding the location of multiple vehicles (e.g., multiple children, spouse and/or a relative) or any other information that the central receiving station may have. For example, a central receiving station may provide a party, such as a parent, or the operator of the vehicle containing the IPCS 30, any relevant information controlled by the receiving station via an internet connection, by telephone (so called land lines and/or mobile phone service, including to an IPCS 30), or any other desirable method. Thus allowing a parent to monitor the location of their children (or at least the vehicle to which the IPCS 60 is attached). In addition, any object transmitting positional information, such as a briefcase, personal effects, or a pet containing a transmitter, may be monitored and/or tracked.

The computer or computer network running the electronic mapping software can process the locational information. For example, where locational information is GPS location information and is accompanied by unique ID information, the electronic mapping software may “map” the location of the PIR 74. A display generated by the electronic mapping software may then include this information. For example, where the electronic mapping software is configured to create an out put of a display of a map on a computer controlled video screen, the GPS data (and unique ID information) may be incorporated into the displayed map.

As additional transmissions occur, the displayed map may be updated to reflect the most recent information. Such a map may aid the user, by accurately allowing “real-time” location of the desired objects. In addition, two or more positional information points and the time associated therewith may be used to calculate acceleration and/or a rate of travel. Thus, where a parent is concerned about the driving habits of a child the parent may prevent drunk driving and receive an alert if the child exceeds a pre-determined speed (e.g., an alert may be transmitted by a central receiving station to the parent).

The invention may also be used to alert a third party if the IPCS 60 is within a pre-defined area, for example, a court may restrict a repeat offender from returning to one or more bars or taverns (“hot spots”) in which case the location of the bar or tavern may be noted and an alarm sounded or re-activation of the car ignition prevented.

Using a system of the present invention, may allow for “bread crumbing” or the calculated reconstruction of the movements of PIR 74 units. A computer system 70 in communication with IPCS 60, which may be through transceiver 72, may receive and store individual locational data packets from one or more PIR 74 units or alternative objects. The unique ID of each unit and the transmission or reception time of each data packet may be stored in a memory associated with the data packet. By executing an appropriate command, the computer may reconstruct the movements of one or more PIR 74 units over time from these individual data packets, using each data packet as an individual data point. Alternatively, the computer may provide a “real time” display of the relative location of one or more PIR 74 units.

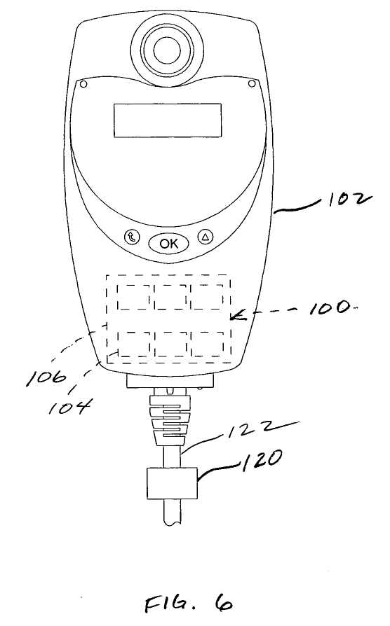

It should be noted that while the various illustrated embodiments show the IPCS of the present invention as an adapter for connection to an existing breathalyzer device, it is also contemplated according to the present invention as illustrated in FIG. 6 that an IPCS 100 may be incorporated into a breathalyzer handset 102. That is, the various components 104 of the IPCS 100 (as previously described herein) may be provided on a printed circuit board 106 of the handset 102 such that the IPCS 100 is fully integrated into the breathalyzer handset 102. It is also contemplated that the IPCS 100 could be integrated into the control system of the breathalyzer, such as control unit 35 shown in FIG. 2A. As further illustrated in FIG. 6, an IPCS 120 could be separately provided as an integral part of the cable 122 that interconnects the handset 102 to the control system. Likewise, components of the system could be provided in both the cord 122 and the handset 102.

While this invention has been described in certain illustrative embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A system for transmitting or receiving positional information in connection with a sobriety interlock system, comprising:
an interlock position communication system having a position information receiver connected to a microcontroller and a wireless communication device, wherein the interlock position communication system is configured to connect to a sobriety interlock system.

2. The system of claim 1, wherein the position information receiver is a global positioning satellite receiver.

3. The system of claim 1, wherein the sobriety interlock system is a breathalyzer hard wired into a motor vehicle.

4. The system of claim 1, further comprising a subscriber identification module card in communication with the wireless communication device.

5. The system of claim 1, wherein the wireless communication device is capable of communication with a mobile phone network.

6. The system of claim 5, wherein the wireless communication device is capable of detecting and adapting its communication protocol to the mobile phone network.

7. The system of claim 1, wherein the interlock position communication system is configured to track or monitor the location of a second interlock position communication system.

8. The system of claim 1, further comprising a parent device that communicates with at least one child or remote device.

9. The system of claim 1, further comprising a central receiving station configured to receive and process positional information from the interlock position communication system.

10. The system of claim 1, further comprising a display screen in connection with the interlock position communication system.

11. A method of transmitting positional information associated with a sobriety interlock system, the method comprising:
providing a position information receiver connected to a microcontroller and a wireless communication device;
connecting the positional information receiver to a sobriety interlock system; and
transmitting positional information by wireless communication to a remote site.

12. The method of claim 11, wherein providing the position information receiver comprises providing a global positioning satellite receiver.

13. The method of claim 11, wherein connecting the position information receiver includes connecting the position information receiver to a breathalyzer hard wired into a motor vehicle.

14. The method of claim 11, further comprising using a subscriber identification module card to communicate with the wireless communication device.

15. The method of claim 14, further comprising communicating with a mobile phone network.

16. The method of claim 15, further comprising detecting and adapting a communication protocol to the mobile phone network.

17. The method of claim 11, further comprising tracking or monitoring the location of a second interlock position communication system.

18. The method of claim 11, further comprising providing a central receiving station configured to receive and process positional information from the interlock position communication system.

19. The method of claim 11, further comprising providing a display screen in connection with the interlock position communication system.

20. A position transmitting device comprising:
a position information receiver connected to a microcontroller;
a wireless communication device; and
a sobriety interlock system in communication with the wireless communication device, the wireless communication device being capable of communication with an existing mobile phone network.
